(19) United States
(12) Patent Application Publication
(10) Pub. No.: US 2026/0246614 A1
(43) Pub. Date: Aug. 20, 2026

(54) SYSTEMS AND METHODS FOR GENERATING EXTERNAL OPENSOURCE DATASETS USING DATASET TUNING OF ENCRYPTED INTERNAL DATASETS WHILE MAINTAINING SECURITY OF THE ENCRYPTED INTERNAL DATASETS

(71) Applicant: Capital One Services, LLC, McLean, VA (US)

(72) Inventors: Samuel Sharpe, Somerville, MA (US); Brian Barr, Schenectady, NY (US)

(73) Assignee: Capital One Services, LLC, McLean, VA (US)

(21) Appl. No.: 19/054,677

(22) Filed: Feb. 14, 2025

(51) Int. Cl. H04L 9/08; H04L 9/06

(52) U.S. Cl. CPC H04L 9/0819; H04L 9/0643

(57) ABSTRACT

Systems and methods for dataset tuning that provide a method to approximate internal data using external, potentially opensource, datasets. As one example, systems and methods for generating public datasets with similar statistics to internal datasets, providing an opensource replacement to internal data. In particular, the systems and methods provide the internal replacement data by computing corpus n-gram statistics of the internal. The system may then determine the n-gram statistics of the tokenized data as opposed to the raw data.

### BACKGROUND

Artificial intelligence (AI) models are trained through a process that involves feeding large amounts of data into an algorithm and adjusting the model based on the patterns it detects. The process begins by selecting or designing a model architecture suitable for the task, such as a neural network for tasks like image recognition or natural language processing. Next, the model is initialized with random weights—parameters that the model uses to make predictions. During training, the model is given input data and produces an initial output, which is compared to the expected or “ground truth” output. This comparison is quantified using a loss function, which calculates the error between the model's predictions and the correct answers. To reduce this error, the model's weights are adjusted iteratively through a process known as backpropagation, which updates weights based on the gradient of the loss function, often using optimization techniques like gradient descent.

As training progresses, the model gradually learns to identify patterns in the data, improving its accuracy over time. In supervised learning, where labeled data is provided, the model learns to map inputs to specific outputs. In unsupervised learning, the model finds structures or patterns within unlabeled data, and in reinforcement learning, it learns through trial and error by receiving rewards or penalties for its actions. Models are typically trained over multiple epochs, or full passes through the training dataset, to fine-tune their performance. The training process is computationally intensive and can take hours to weeks, depending on the model's complexity and the size of the dataset. Once trained, the model is evaluated on a separate set of data (the validation or test set) to ensure it generalizes well to new, unseen data. If the model performs well, it is ready for deployment, where it can make predictions or decisions in real-world applications.

### SUMMARY

However, to have a properly trained model, the model requires quality training data. For example, quality training data is essential for training models because the model learns directly from this data, and its performance is closely tied to the accuracy, relevance, and completeness of the information it receives. High-quality data enables the model to recognize true patterns rather than random noise, leading to more accurate and reliable predictions. If the data is incorrect, inconsistent, or biased, the model will learn from these flaws, which can result in poor performance, unexpected outcomes, and potentially harmful biases. High-quality training data typically has several key characteristics: it is accurate, meaning that the data points are correct and match their labels or intended use; it is representative, covering the diversity and range of scenarios the model will encounter in real-world applications; it is balanced, containing a well-distributed set of classes or categories to avoid model bias toward certain outcomes; and it is consistent, with uniform standards applied to the data collection, labeling, and formatting. Additionally, high-quality training data is comprehensive, offering enough examples for the model to generalize effectively while avoiding overfitting to overly specific cases. When data meets these criteria, it gives the model a solid foundation, enabling it to perform well, generalize across different situations, and maintain robustness even when facing new, unseen data.

With this in mind, training a model on internal data can often be more effective than using external data because internal data is typically more relevant, specific, and representative of the environment in which the model will be deployed. Internal data reflects the unique characteristics, terminology, and user behavior of the specific context, making it easier for the model to generalize effectively to similar tasks. This relevance reduces the likelihood of the model learning from irrelevant patterns or noise, which can happen with general external data sources that might include varied and inconsistent information. Additionally, internal data tends to have a higher quality of annotations and labels, as it is often curated and checked by experts familiar with the business or domain. Internal data also allows for more efficient model maintenance and updates, as it provides continuous feedback specific to actual performance needs, enabling more targeted model retraining and adjustments. Ultimately, models trained on internal data are likely to perform better in real-world applications because they have been optimized for the exact conditions they will encounter. Unfortunately, the amount of internal data is often limited and its use may have privacy and/or compliance issues. Moreover, using internal data in any amount may risk incorporating elements of this data that could violate privacy standards or regulatory requirements.

Systems and methods are described herein for dataset tuning that provides a method to approximate internal data using external, potentially opensource, datasets. As one example, systems and methods are described herein for generating public datasets with similar statistics to internal datasets, providing an opensource replacement to internal data. In particular, the systems and methods provide the internal replacement data by computing corpus n-gram statistics of the internal. However, as discussed above, even using internal data for this purpose may risk violating privacy standards or regulatory requirements. To overcome this risk, the systems and methods first tokenize the internal data, providing a level of encryption and obfuscation that maintains the privacy standards or regulatory requirements. The system may then determine the n-gram statistics of the tokenized data as opposed to the raw data.

The system may similarly tokenize external datasets and determine their n-gram statistics. After which, the system may generate vectors of the internal and external n-gram statistics to determine weights to apply to the external dataset to determine feature vectors closest to the internal dataset. The weights may then be applied to the raw data of the external datasets to generate a public dataset that has similar statistics to the internal dataset, providing an opensource replacement to the internal data which is entirely free of the risk of privacy standards or regulatory requirements.

In some aspects, systems and methods are described herein for generating external opensource datasets using dataset tuning of encrypted internal data. For example, the system may receive a first dataset, wherein the first dataset comprises sensitive data. The system may receive a second dataset, wherein the second dataset comprises non-sensitive data. The system may generate a first tokenized representation of the first dataset, wherein the first tokenized representation comprises a first encryption of the sensitive data. The system may generate a second tokenized representation of the second dataset, wherein the second tokenized representation comprises a second encryption of the non-sensitive data. The system may determine a shared encryption token in the first tokenized representation and the second tokenized representation. The system may determine a first feature vector of a first n-gram statistic of the shared encryption token in the first tokenized representation. The system may determine a second feature vector of a second n-gram statistic of the shared encryption token in the second tokenized representation. The system may generate, using an optimization procedure, a feature weight based on a difference between the first feature vector and the second feature vector. The system may generate a third dataset based on applying the feature weight to the second dataset.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for comparing tokenized representations of datasets in accordance with one or more embodiments.

FIG. 2 shows an illustrative diagram for generating unencrypted replacement data, in accordance with one or more embodiments.

FIG. 3 shows illustrative components for a system used to perform an optimization procedure, in accordance with one or more embodiments.

FIG. 4 shows a flowchart of the steps involved in generating external opensource datasets using dataset tuning of encrypted internal data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

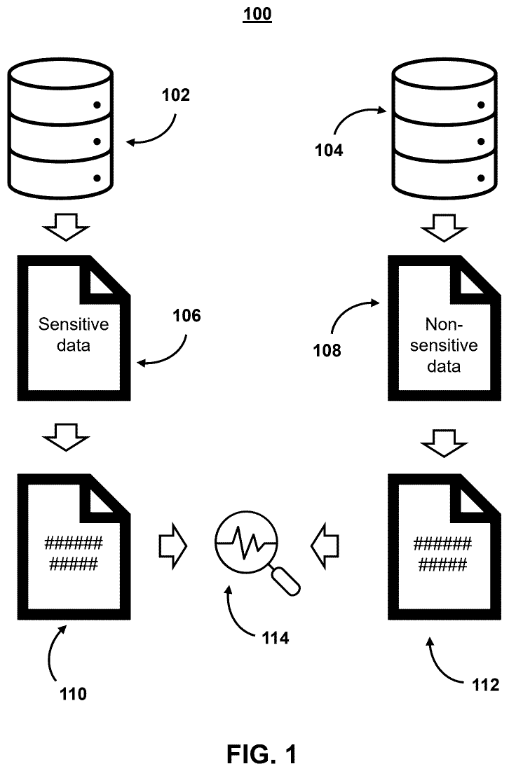

FIG. 1 shows an illustrative diagram for comparing tokenized representations of datasets in accordance with one or more embodiments. For example, system 100 may show a system for generating external opensource datasets using dataset tuning of encrypted internal data. For example, system 100 shows dataset 102 and dataset 104. System 100 may receive content from dataset 102. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user-generated content may include content created by another, but consumed and/or published by the user.

For example, dataset 102 may comprise raw sensitive data of internal communications. The raw sensitive data may be unencrypted. System 100 may receive content from dataset 102 and dataset 104 by establishing access protocols that differentiate the handling of sensitive and non-sensitive data. Dataset 102, containing raw sensitive data from internal communications, may be accessed under strict privacy and security guidelines to ensure that any personally identifiable information (PII) or confidential details remain protected throughout processing. This data may be transferred to system 100 through secure, isolated channels that control access permissions and log each access event for auditing. Since the data is unencrypted, system 100 may first apply encryption or pseudonymization procedures to safeguard it before further processing, depending on the system's purpose and compliance requirements. Conversely, dataset 104 comprises raw non-sensitive data of internal communications and is accessed with comparatively relaxed controls. System 100 may directly retrieve this non-sensitive data, which does not contain protected or confidential information, allowing it to be processed without requiring immediate security transformations. By establishing clear distinctions between the two datasets, system 100 can integrate both sensitive and non-sensitive information effectively, applying additional protective measures to dataset 102 as needed while utilizing dataset 104 with fewer constraints. This structured approach allows system 100 to handle different data types efficiently while adhering to privacy and security policies.

System 100 may also receive content from dataset 104. Dataset 104 may comprise raw non-sensitive data of communications from a plurality of opensource locations. The raw non-sensitive data may also be unencrypted. System 100 receives content from dataset 104, which contains raw non-sensitive data of communications sourced from various open-source locations, through a streamlined data ingestion pipeline designed to handle unencrypted, non-sensitive information efficiently. Since the data originates from open sources, it typically lacks privacy or confidentiality restrictions, allowing system 100 to access and process it with minimal security overhead. The system connects to the data sources—such as public repositories, open forums, and social media channels—through secure API integrations, web scraping methods, or direct data downloads, depending on the source type and format. Upon retrieval, system 100 may organize the data into structured formats that are compatible with downstream processing requirements, enabling easy analysis, transformation, and storage. This direct access to unencrypted, non-sensitive content allows system 100 to aggregate diverse types of open communication data quickly, supporting applications like natural language processing, model training, or trend analysis without the need for additional data privacy safeguards.

System 100 may receive sensitive data 106 from dataset 102. Sensitive data may refer to information that must be protected due to its potential to impact an individual's privacy, security, or rights if exposed. This data includes personally identifiable information (PII) like names, addresses, social security numbers, or financial information, as well as protected health information (PHI), which encompasses medical records and health histories. Sensitive data may also extend to corporate information, such as trade secrets, proprietary algorithms, or business plans, which, if disclosed, could harm a company's competitive advantage. In the digital age, sensitive data further encompasses biometrics, genetic information, and any data that could uniquely identify or profile an individual, including their browsing history, location data, or personal preferences. Due to its nature, sensitive data may be subject to strict regulatory standards, such as the GDPR in the EU or HIPAA in the U.S., which mandate robust protections to prevent unauthorized access, loss, or misuse. Protecting sensitive data may be crucial not only to uphold privacy rights but also to maintain trust and security in digital systems, making careful handling, encryption, and anonymization essential practices in data management.

System 100 may receive non-sensitive data 108 from dataset 104. Non-sensitive data may refer to information that does not require stringent protection or confidentiality measures, as its exposure is unlikely to compromise an individual's privacy, security, or rights. This type of data generally includes information that is publicly available or readily accessible without causing harm if shared. Examples of non-sensitive data include publicly accessible data like business addresses, product information, publicly disclosed financial summaries, generic user statistics, or non-identifying usage metrics. Because non-sensitive data does not contain personally identifiable information (PII) or any proprietary details that could affect individuals or organizations, it can often be shared or stored without complex security safeguards. In business and analytics contexts, non-sensitive data may be highly valuable as it can be used freely for research, analysis, or product development without concerns about compliance with strict privacy regulations. Although less protected than sensitive data, it is still important to manage non-sensitive data responsibly, ensuring accuracy and relevance, as improper handling can still impact data quality and usability.

System 100 may generate tokenized representation 110 of sensitive data 106. For example, system 100 may generate a first tokenized representation of dataset 102, wherein the first tokenized representation comprises a first encryption of the raw sensitive data. For example, System 100 generates a first tokenized representation of dataset 102 by processing the raw sensitive data into discrete units, or tokens, which are then encrypted to form a secure, encoded version of the original data. Tokenization involves breaking down the text into smaller, manageable parts—such as words, subwords, or characters—that maintain the structure and meaning of the data without retaining the raw, sensitive form. A tokenized representation can vary depending on the application, often taking the form of words (e.g., “data,” “privacy”), subwords (e.g., “priv-” and “-acy”), or character sequences that represent portions of the text. Examples of tokenized representations include sequences of words converted into unique identifiers, like “data” becoming token ID 123, or subwords and characters encoded as tokens that correspond to specific vocabulary items in the model's dictionary. To create these tokenized representations, system 100 uses a predefined vocabulary or encoding scheme, such as Byte Pair Encoding (BPE), WordPiece, or SentencePiece, which maps each token in the dataset to a unique identifier. Once tokenized, each identifier undergoes an encryption process—such as hashing, symmetric encryption, or public-key encryption—ensuring the tokens cannot be directly traced back to the raw sensitive data. This encryption process produces a first tokenized representation that securely encodes the sensitive text, enabling system 100 to work with the data in a privacy-compliant manner while retaining the structural information necessary for tasks like analysis, language processing, or machine learning. Through this approach, system 100 can manage and utilize sensitive data 106 securely, applying tokenization and encryption as protective measures that transform the raw content into a safe, encoded form suitable for further processing.

System 100 may generate tokenized representation 112 based on non-sensitive data 108, wherein tokenized representation 112 comprises a second encryption of the raw non-sensitive data. System 100 generates a second tokenized representation of dataset 104 by processing the raw non-sensitive data into tokens and applying encryption to create a secure, structured representation. Initially, system 100 may tokenize the non-sensitive data 108 by breaking it down into smaller units, such as words, subwords, or characters, based on a predefined vocabulary or encoding scheme, like Byte Pair Encoding (BPE) or WordPiece. This process maps each token in the dataset to a unique identifier, effectively transforming the raw data into a tokenized sequence that preserves the essential structure and meaning without retaining its unprocessed form. Once the tokenization is complete, system 100 may encrypt each token, either by hashing the token identifiers, using symmetric encryption, or applying a public-key encryption technique. This encryption layer, while perhaps less stringent than for sensitive data 106, ensures that the tokenized representation of non-sensitive data 108 is secure and anonymized, preventing straightforward traceability to the original data. The second tokenized and encrypted representation allows system 100 to use and analyze the non-sensitive data 108 effectively while maintaining data protection standards, enabling secure processing and storage for tasks such as training models or conducting analytical studies.

System 100 may determine shared encryption token 114 in tokenized representation 110 and tokenized representation 112. For example, system 100 determines shared encryption token 114 by analyzing tokenized representation 110 (derived from sensitive data 106) and tokenized representation 112 (derived from non-sensitive data 108) to identify tokens that are common to both datasets. To achieve this, system 100 compares the encrypted tokens within each representation, using specific criteria to identify tokens that exhibit similar encrypted values or characteristics across the two datasets. Shared encryption token 114 may comprise these matching tokens, which represent data elements—such as words, phrases, or character sequences—that appear in both the sensitive and non-sensitive datasets, despite being encrypted differently. The criteria used by system 100 to identify shared encryption tokens may include examining tokens with identical or highly similar encryption hashes, checking for equivalent token lengths or patterns, or analyzing tokens that consistently align in context or frequency across both tokenized representations. Shared encryption token 114 may encapsulate these matching encrypted tokens, serving as a bridge between the two datasets, which enables system 100 to perform further analysis, correlation, or integration tasks on combined data elements without compromising the encryption and security of the sensitive or non-sensitive information.

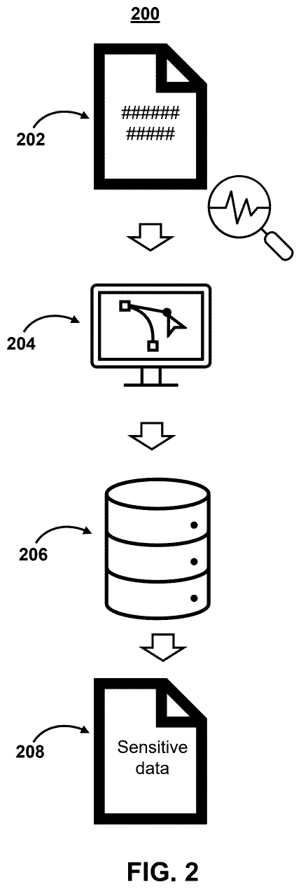

FIG. 2 shows an illustrative diagram for generating unencrypted replacement data, in accordance with one or more embodiments. For example, system 200 may show a system for generating external opensource datasets using dataset tuning of encrypted internal data. As shown in FIG. 2, system 200 may determine feature vector 204 based on a first n-gram statistic of a shared encryption token (e.g., shared encryption token 114 (FIG. 1)) in a first tokenized representation. Additionally or alternatively, system 200 may determine a second feature vector of a second n-gram statistic of the shared encryption token in the second tokenized representation.

System 200 determines feature vector 204 by analyzing a first n-gram statistic derived from a shared encryption token, such as shared encryption token 114, within a first tokenized representation. An n-gram is a contiguous sequence of “n” tokens (words, subwords, or characters) from a given text, where the value of “n” determines the length of each sequence and, consequently, the amount of contextual information captured. Types of n-grams include unigrams (1-gram), bigrams (2-gram), trigrams (3-gram), and higher-order n-grams, each increasing the sequence length and the amount of context preserved. The primary difference between these types lies in how much contextual or sequential information they capture; unigrams represent individual tokens independently, bigrams represent pairs of tokens and capture adjacent relationships, while trigrams and higher-order n-grams capture increasingly extended contexts, representing phrases or patterns of language usage.

Various statistics can be based on n-grams, such as frequency, probability, conditional probability, and pointwise mutual information (PMI). Frequency counts how often an n-gram appears, providing a basic measure of commonality. Probability provides a normalized version of frequency, showing how likely an n-gram is to occur within a given context or corpus. Conditional probability extends this by calculating the likelihood of a specific token given its preceding tokens (e.g., the probability of “morning” following “good”), which is particularly useful for modeling text generation or predictive tasks. Pointwise mutual information (PMI) measures the association between tokens within an n-gram, identifying which n-grams appear together more often than would be expected by chance, and offering insights into meaningful word combinations or phrases.

To create feature vector 204, system 200 may extract one or more of these statistics based on n-grams involving the shared encryption token in the tokenized representation. By encoding these statistics into a vector format, feature vector 204 represents the shared encryption token's role within various contexts of the data. This feature vector, built from n-gram statistics, allows system 200 to analyze and use token-level relationships while preserving the structure and privacy of the underlying data.

System 200 may generate, using an optimization procedure, a feature weight based on a difference between a first feature vector and the second feature vector. For example, system 200 generates a feature weight based on the difference between a first feature vector and a second feature vector by applying an optimization procedure that aims to minimize the error or discrepancy between a target outcome and the current feature weight assignments. First, the system computes the difference between corresponding elements in the two feature vectors, where each element represents a specific statistical or contextual attribute derived from n-grams or other relevant features. This difference highlights which features are more or less prominent across the vectors, identifying patterns or discrepancies that could be adjusted for alignment.

To assign feature weights that meaningfully reflect these differences, system 200 defines an objective or loss function that quantifies the error between the desired and current state based on the feature weights. Using a gradient-based optimization algorithm like gradient descent, the system calculates the gradient of this loss function with respect to each feature weight, revealing the direction and magnitude of adjustment needed for each weight to reduce the overall error. With each iteration, system 200 updates the weights by a small step in the direction that reduces the loss, progressively refining the weights until the loss converges to a minimum or meets a pre-defined threshold. This process yields optimized feature weights that balance the influence of each feature difference, emphasizing the most informative aspects of the vectors. These final weights serve to represent the differences accurately and inform further analyses, such as model training, pattern recognition, or similarity scoring, enabling system 200 to apply these learned distinctions effectively.

A system that executes an optimization procedure to determine the weights of a dataset, aiming to align feature vectors as closely as possible to an internal dataset, typically functions by iteratively adjusting these weights to minimize a defined error metric. The fundamental objective is to transform the input feature vectors so that their representation in the feature space is nearly identical to the corresponding vectors in the internal dataset. The measure of “closeness” between these vectors can be calculated using distance metrics, such as the Euclidean distance, cosine similarity, or a custom loss function. In a specific approach using an optimization algorithm, the system may employ a quadratic loss function defined as:

$$min [ ( {w}_{1} {x}_{1} + … + {w}_{n} {x}_{n} ) - {x}_{{internal ]}^{2}}$$

where 0≤xᵢ≤1 for all feature components xᵢ. This formulation describes an optimization problem in which the system seeks to minimize the squared difference between a weighted combination of feature values from the input dataset and the corresponding values in the internal dataset. Here, x₁, x₂, ..., xₙ represent the features of the input dataset, each scaled between 0 and 1, while w₁, w₂, ..., wₙ are the weights applied to each feature to optimize the alignment.

The algorithm begins with an initial set of weights, often chosen at random or using a heuristic method. A loss function is then defined as the squared difference between the weighted sum of the input feature vectors and the internal dataset's feature values. During each iteration, the system performs a forward pass, computing the current value of the loss function using the existing weights. Next, it employs a backward pass, where gradient-based optimization techniques, such as Stochastic Gradient Descent (SGD), Adam, or RMSprop, are used to calculate how the weights should be adjusted. These gradients indicate the direction in which the weights need to change to minimize the loss.

The weights are then updated by taking a step in the direction of the negative gradient, scaled by a learning rate η, which controls the step size and influences the convergence speed. The process is repeated until the loss converges to a minimal value, or the system reaches a predefined number of iterations. Throughout the optimization, the constraint 0≤xᵢ≤1 is enforced, ensuring that the input features remain within the specified bounds.

This algorithm effectively finds the optimal set of weights that minimize the distance between the transformed feature vectors and the internal dataset. The use of quadratic loss ensures that larger deviations are penalized more heavily, promoting precise alignment. Additionally, techniques like regularization can be incorporated to prevent overfitting, while mini-batch processing can improve computational efficiency when dealing with large datasets. This structured approach is crucial in applications like machine learning, where the accurate representation of feature vectors can significantly impact the model's performance and generalizability.

System 200 may generate dataset 206 based on applying the feature weight to a public dataset, wherein dataset 206 comprises unencrypted replacement data for the sensitive data (e.g., sensitive data 106 (FIG. 1)). For example, system 200 generates dataset 206 by applying the optimized feature weights to a public dataset, transforming it into unencrypted replacement data that approximates the statistical and contextual properties of the sensitive data. First, the system may select a public dataset with a structure and content that resemble the general nature of the sensitive data, ensuring that it contains compatible topics, vocabulary, and patterns. Using the feature weights previously determined through analysis of the sensitive data's feature vectors, system 200 modifies or reweights specific features within the public dataset, adjusting word frequencies, n-gram probabilities, or other linguistic attributes to align more closely with the sensitive data's characteristics. This application of feature weights might involve amplifying certain word pairings, adjusting the likelihood of specific phrases, or replicating stylistic patterns that mirror those found in the sensitive dataset.

Through this process, the public dataset is transformed into dataset 206, where the modified text elements preserve essential patterns and structures observed in the sensitive data but without exposing any actual sensitive information. Because dataset 206 comprises unencrypted replacement data, it can be used directly in analyses, model training, or testing environments where privacy is critical. By leveraging optimized feature weights to generate replacement data, system 200 creates a dataset that captures the statistical and contextual essence of the sensitive information, providing a secure, privacy-preserving alternative that can stand in for the original data in a variety of applications.

In some embodiments, system 200 may use the unencrypted replacement data to populate a chatbot and/or present information on a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

For example, system 200 may use the unencrypted replacement data in dataset 206 to populate a chatbot or present information on a user interface by integrating the replacement data as a source of knowledge or response patterns within the chatbot's conversational framework. First, system 200 feeds dataset 206 into the chatbot's natural language processing (NLP) engine, which analyzes the data to extract relevant information, topics, and typical user inquiries. This dataset helps the chatbot learn response structures, key phrases, and specific vocabulary related to the original sensitive data while preserving user privacy. The unencrypted nature of dataset 206 allows the chatbot to access and use this information without requiring additional security protocols, enabling smooth interaction with end-users.

When the chatbot receives a query, it references the patterns and knowledge embedded in dataset 206 to generate contextually relevant responses. For instance, if the sensitive data originally contained customer support scenarios, the replacement data in dataset 206 would provide similar scenarios that the chatbot can use to address user inquiries accurately and consistently. On a user interface, system 200 can present information derived from dataset 206 by rendering response options, suggested questions, or direct informational content based on common themes in the replacement data. This presentation of information on the user interface allows users to interact seamlessly with the chatbot, as dataset 206 provides a rich yet secure foundation for the system to pull from, ensuring that users receive accurate, relevant responses without compromising sensitive data.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user or a customized desktop environment. In some embodiments, the user profile may be a digital representation of a person's identity. The data in the user profile may be generated based on the system actively or passively monitoring.

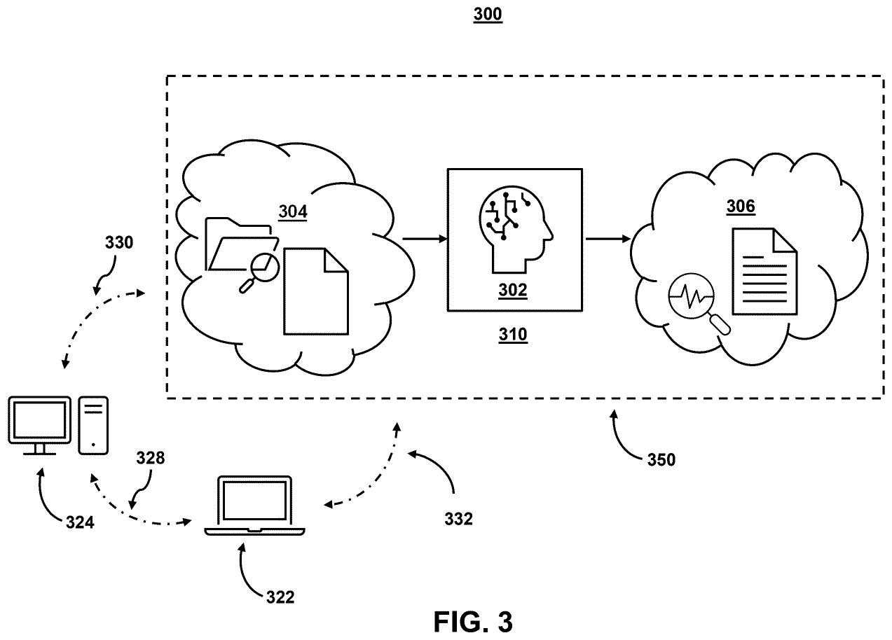

FIG. 3 shows illustrative components for a system used to perform an optimization procedure, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically store information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application-specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application-specific such that design of the circuit is customized for a given application. In some embodiments, system 300 may use an integrated circuit system where one or more integrated circuits are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, an artificial intelligence model, etc. (which may be referred to collectively as “models” herein). In recent years, the use of artificial intelligence, including, but not limited to, machine learning, deep learning, etc. (referred to collectively herein as artificial intelligence models, machine learning models, or simply models), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in generating better training data.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., determining n-grams, identifying tokenized representations, matching shared representations, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., determining n-grams, identifying tokenized representations, matching shared representations, etc.).

In some embodiments, the model (e.g., model 302) may automatically perform actions based on outputs 306. In some embodiments, the model (e.g., model 302) may not perform any actions. The output of the model (e.g., model 302) may be used to generate replacement data and/or make predictions based on the replacement data.

In some embodiments, the system may generate predictions related to financial services. For example, the system may use one or more models and/or applications to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjust the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications is in place.

In some embodiments, the system architecture may use a microservice approach. Such systems may use two types of layers: front-end layer and back-end layer where microservices reside. In this kind of architecture, the role of the API layer 350 may provide integration between front-end and back-end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or opensource API platforms and their modules. API layer 350 may use a developer portal. API layer 350 may use strong security constraints applying WAF and DDoS protection, and API layer 350 may use RESTful APIs as standard for external integration.

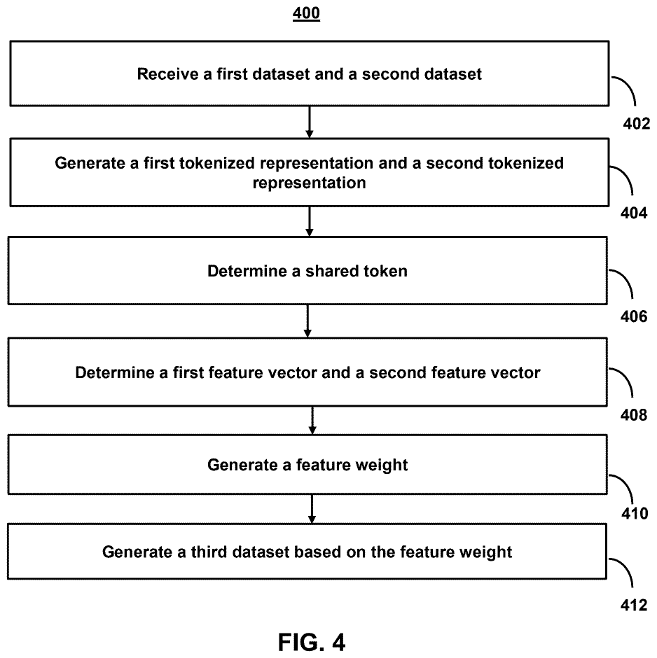

FIG. 4 shows a flowchart of the steps involved in generating external opensource datasets using dataset tuning of encrypted internal data, in accordance with one or more embodiments. For example, the system may use process 400 (e.g., as implemented on one or more system components described above) in order to generate replacement internal data.

At step 402, process 400 (e.g., using one or more components described above) receives a first dataset and a second dataset. For example, the system may receive a first dataset and a second dataset, wherein the first dataset comprises sensitive data and the second dataset comprises non-sensitive data. As another example, the system receives a first dataset and receives a second dataset, wherein the first dataset comprises sensitive data and the second dataset comprises non-sensitive data. In some embodiments, the first dataset may comprise raw sensitive data of internal communications, wherein the raw sensitive data is unencrypted, while the second dataset comprises raw non-sensitive data of communications from a plurality of opensource locations, wherein the raw non-sensitive data is unencrypted.

At step 404, process 400 (e.g., using one or more components described above) generates a first tokenized representation and a second tokenized representation. For example, the system may generate a first tokenized representation of the first dataset and a second tokenized representation of the second dataset. As another example, the system may generate a first tokenized representation of the first dataset and generate a second tokenized representation of the second dataset, wherein the first tokenized representation comprises a first encryption of the sensitive data, and wherein the second tokenized representation comprises a second encryption of the non-sensitive data.

In some embodiments, the system may generate the first tokenized representation of the first dataset by determining a first word in the first dataset and generating a byte pair encoding of the first word. For example, to generate the first tokenized representation of the first dataset, the system begins by identifying a first word within the dataset's text. This word is then processed using a byte pair encoding (BPE) algorithm, which breaks down the word into smaller subword units, or byte pairs, based on frequency patterns in the dataset. BPE operates by iteratively identifying and merging the most common character pairs within words until each word is represented as a sequence of subword tokens. For the first word, the system starts by analyzing the individual characters, then progressively combines frequently co-occurring character pairs to form subwords that retain meaning while being compact and reusable across multiple words. The result is a series of subword tokens that collectively represent the original word but in a tokenized format. This BPE-based tokenization allows the system to handle rare words and complex vocabulary flexibly, as infrequent or new words can be represented as combinations of existing subwords, rather than requiring an entirely new token. Once the first word is transformed into its BPE token sequence, the system continues this process for all other words in the dataset, ultimately generating a comprehensive tokenized representation that captures the dataset's vocabulary in an efficient and compressed format. This tokenized representation, composed of BPE tokens, is then used for further analysis, model training, or secure data processing, allowing the system to work with a manageable, structured, and reusable vocabulary.

At step 406, process 400 (e.g., using one or more components described above) determines a shared token. For example, the system may determine a shared token in the first tokenized representation and the second tokenized representation. As another example, the system may determine a shared encryption token in the first tokenized representation and the second tokenized representation.

At step 408, process 400 (e.g., using one or more components described above) determines a first feature vector and a second feature vector. For example, the system may determine a first feature vector based on the shared token in the first tokenized representation and a second feature vector based on the shared token in the second tokenized representation. As another example, the system may determine a first feature vector of a first n-gram statistic of the shared encryption token in the first tokenized representation and a second feature vector of a second n-gram statistic of the shared encryption token in the second tokenized representation.

In some embodiments, the system determines the first feature vector of the first n-gram statistic of the shared encryption token in the first tokenized representation by determining a first n-gram corresponding to the shared encryption token and determining a first frequency of the first n-gram in the first tokenized representation. For example, the system may determine a first feature vector of the first n-gram statistic of the shared encryption token in a first tokenized representation by identifying and analyzing n-gram patterns associated with the shared encryption token. First, the system may scan through the first tokenized representation, which contains sequences of encrypted tokens, to identify occurrences of the shared encryption token within specific n-gram contexts, such as unigrams (single tokens), bigrams (two-token sequences), or trigrams (three-token sequences). Once the system locates the first n-gram that includes the shared encryption token, it calculates the frequency of this n-gram within the entire tokenized dataset. This frequency indicates how often the shared encryption token appears in conjunction with particular surrounding tokens, providing insight into its contextual usage. The calculated frequency of this first n-gram may serve as a key component of the feature vector, representing the relative prominence of the shared encryption token in specific contexts. The system may also include additional frequency metrics for different n-gram lengths or other n-grams associated with the shared token, forming a feature vector that encapsulates various aspects of the token's distribution and contextual relationships. By compiling these statistics into a feature vector, the system effectively quantifies the n-gram patterns surrounding the shared encryption token, enabling downstream tasks such as similarity analysis, language modeling, or data synthesis based on the token's contextual usage patterns within the first tokenized representation.

In some embodiments, the system may determine the first feature vector of the first n-gram statistic of the shared encryption token in the first tokenized representation by determining a first n-gram corresponding to the shared encryption token, determining a second n-gram corresponding to the shared encryption token, and determining a position of the first n-gram in relation to the second n-gram. For example, to determine the first feature vector of the first n-gram statistic for a shared encryption token in a tokenized representation, the system first identifies relevant n-grams involving this token across different positions and contexts. It starts by locating instances of a first n-gram containing the shared encryption token within the tokenized dataset, capturing patterns or sequences where the token appears with other tokens. Next, the system identifies a second n-gram that also includes the shared encryption token, with each n-gram potentially representing different contexts or neighboring tokens that co-occur with the shared token. After identifying both n-grams, the system calculates their relative positions within the tokenized dataset, noting the distance and sequence between the occurrences of the first and second n-grams. This positional information reveals how frequently and in what order the shared encryption token appears alongside various tokens, contributing to an understanding of its contextual patterns. By encoding these frequencies and positional relationships into a feature vector, the system builds a structured representation of the shared encryption token's usage within the data. This feature vector encapsulates both the frequency of co-occurrence with neighboring tokens and the token's positional relationships, enabling the system to capture nuanced contextual information that can be used in downstream analyses, such as language modeling or similarity assessments.

In some embodiments, the system may determine the first feature vector of the first n-gram statistic of the shared encryption token in the first tokenized representation by determining a first n-gram corresponding to the shared encryption token, determining a second n-gram corresponding to the shared encryption token, and determining a likelihood of the first n-gram preceding the second n-gram. For example, to determine the first feature vector of the first n-gram statistic for a shared encryption token in a tokenized representation, the system begins by identifying occurrences of the shared encryption token within different n-gram contexts. First, it locates instances of a specific first n-gram that contains the shared encryption token, capturing one set of contextual usage patterns for the token. The system then identifies instances of a second n-gram that also includes the shared encryption token but may reflect a different contextual relationship. Once both n-grams are identified, the system calculates the likelihood of the first n-gram appearing before the second n-gram within the tokenized data sequence. This likelihood reflects how often the first n-gram precedes the second n-gram when the shared encryption token is present, providing insight into temporal or sequential relationships between the contexts in which the token appears. The system then encodes this likelihood, along with other relevant statistics from the n-grams, into a feature vector, capturing not only the frequency but also the directional relationship of the shared encryption token's occurrences. This feature vector, enriched with the likelihood of one n-gram preceding another, offers a structured representation of both frequency and order patterns associated with the token, which can be instrumental in tasks such as predictive modeling, contextual analysis, or synthetic data generation.

In some embodiments, the system determines the first feature vector of the first n-gram statistic of the shared encryption token in the first tokenized representation by determining a first n-gram corresponding to the shared encryption token, determining a second n-gram corresponding to the shared encryption token, and determining a position of the first n-gram in relation to the second n-gram. For example, to determine the first feature vector of the first n-gram statistic for a shared encryption token in a tokenized representation, the system performs a series of steps to capture contextual and positional relationships between occurrences of the token. It begins by scanning the tokenized dataset to identify instances of a first n-gram that includes the shared encryption token. This n-gram might include the shared token alongside surrounding tokens, capturing a specific context in which the token appears. The system then locates occurrences of a second n-gram that also contains the shared encryption token but within a potentially different context or sequence of neighboring tokens. Once both the first and second n-grams are identified, the system calculates the relative position of the first n-gram in relation to the second n-gram within the tokenized dataset. This involves assessing the distance, ordering, or co-occurrence patterns between the two n-grams, which reveals how frequently they appear near each other and in what sequence. By encoding the positional relationship, frequency, and co-occurrence patterns into a structured feature vector, the system generates a representation that reflects both the prominence and contextual positioning of the shared encryption token within the dataset. This feature vector, encompassing these positional and relational attributes, provides a detailed summary of the token's contextual behavior, which can be applied in subsequent analyses, such as identifying patterns, assessing similarity, or enhancing predictive accuracy in language models.

In some embodiments, the system may determine the first feature vector of the first n-gram statistic of the shared encryption token in the first tokenized representation by determining a first n-gram corresponding to the shared encryption token and determining a first hash value based on the first n-gram in the first tokenized representation. For example, to determine the first feature vector of the first n-gram statistic for a shared encryption token in a tokenized representation, the system begins by identifying a first n-gram that includes the shared encryption token within the sequence of tokens. This first n-gram captures a specific context in which the shared encryption token appears, potentially alongside other tokens that provide valuable contextual information. Once the system isolates this first n-gram, it generates a first hash value based on this n-gram in the tokenized representation. This hashing process converts the n-gram into a fixed-length, unique representation that maintains the contextual information while adding a layer of security, particularly if sensitive data is involved. The hash value represents the n-gram in a compact, encoded form, which can then be used in feature construction without directly exposing the original token content. The hash value, along with other relevant attributes derived from the n-gram, is encoded into a feature vector that characterizes the shared encryption token's usage patterns in the data. This feature vector, which includes the hash representation, allows the system to store and compare the n-gram information securely and efficiently, enabling downstream applications such as similarity analysis, predictive modeling, or synthetic data generation while preserving the token's privacy and structural role within the text. By combining the contextual detail of the n-gram with the hashed identifier, the system can effectively analyze the tokenized data's structure and patterns without compromising the original data integrity.

In some embodiments, the system may determine the first feature vector of the first n-gram statistic of the shared encryption token in the first tokenized representation by determining a first n-gram corresponding to the shared encryption token, determining a second n-gram corresponding to the shared encryption token, and determining a first number of text strings in the first tokenized representation comprising the first n-gram and the second n-gram. For example, to determine the first feature vector of the first n-gram statistic for a shared encryption token in a tokenized representation, the system first identifies two specific n-grams that contain the shared encryption token, referred to here as the first n-gram and the second n-gram. Each n-gram represents different contextual appearances of the shared encryption token within sequences of tokens, capturing the token's usage patterns in varying contexts. Once the system has identified these two n-grams, it calculates the number of unique text strings within the tokenized representation that contain both the first and second n-grams. This count reflects how frequently these n-grams co-occur within the same text strings, providing valuable information on the shared encryption token's contextual prominence and relational patterns across different segments of the data. The system then encodes this count as a feature within a feature vector, forming part of the overall statistical profile for the shared encryption token. This feature vector, which now includes the frequency of co-occurrence for the first and second n-grams within the same text strings, encapsulates both the contextual distribution and co-relational aspects of the shared token in the data. By quantifying this co-occurrence count alongside other relevant statistics, the system creates a feature vector that provides a nuanced representation of how the shared encryption token functions within the tokenized text, supporting analyses like similarity assessment, contextual modeling, and secure data synthesis.

In some embodiments, the system may determine the first feature vector of the first n-gram statistic of the shared encryption token in the first tokenized representation by determining a first n-gram corresponding to the shared encryption token, determining a second n-gram corresponding to the shared encryption token, determining a third n-gram corresponding to the shared encryption token, and determining a syntactical structure in the first tokenized representation comprising the first n-gram, the second n-gram, and the third n-gram. For example, To determine the first feature vector of the first n-gram statistic for a shared encryption token in a tokenized representation, the system begins by identifying multiple n-grams—specifically, a first, second, and third n-gram—that each include the shared encryption token. These n-grams represent different contextual sequences where the shared encryption token appears, possibly surrounded by distinct sets of tokens that offer varied linguistic or semantic information. Once these n-grams are identified, the system analyzes their arrangement and relationships within the tokenized data to uncover any consistent syntactical structure that encompasses all three n-grams. This syntactical structure could manifest as a specific ordering of the n-grams, a repeated pattern in their co-occurrence, or a structural relationship, such as a phrase, clause, or sentence format in which they frequently appear together. By identifying this syntactical structure, the system gains insight into how the shared encryption token functions within broader linguistic patterns. This information is encoded within a feature vector, capturing not only the occurrence and frequency of each n-gram but also the syntactical organization linking them. This feature vector, enriched with syntactical structure data, becomes a detailed representation of the shared encryption token's usage patterns, capturing both individual context and structural relationships within the text. This syntactical feature representation can then be used to inform downstream tasks, such as pattern recognition, natural language understanding, or synthetic data generation, providing a nuanced view of the shared encryption token's role in the dataset.

In some embodiments, the system may determine the first feature vector of the first n-gram statistic of the shared encryption token in the first tokenized representation by determining a first n-gram corresponding to the shared encryption token and determining a first conditional n-gram distribution of the first n-gram in the first tokenized representation. To determine the first feature vector of the first n-gram statistic for a shared encryption token in a tokenized representation, the system begins by identifying a first n-gram that includes the shared encryption token. This n-gram captures a specific context where the shared encryption token appears, potentially alongside neighboring tokens that provide additional meaning. Once the system identifies this n-gram, it proceeds to calculate the first conditional n-gram distribution for the shared encryption token within the tokenized representation. This conditional distribution represents the likelihood of the first n-gram occurring in particular contexts, conditioned on surrounding tokens or sequences within the dataset. For instance, the system may determine how likely the first n-gram is to appear given certain preceding or following tokens, reflecting contextual dependencies that reveal how this token is used in relation to other parts of the text. The conditional n-gram distribution provides insights into how frequently the shared encryption token's context aligns with specific linguistic patterns or structures. The system encodes this information in a feature vector, incorporating the conditional probability values as features that reflect the token's positional and relational patterns within the dataset. By including the conditional distribution in the feature vector, the system creates a nuanced representation of the shared encryption token's usage, capturing both its frequency and its dependence on surrounding textual elements. This feature vector, rich in contextual and conditional data, serves as a valuable input for further tasks such as predictive modeling, text generation, or similarity assessment, enabling the system to understand and replicate the contextual behavior of the shared encryption token within the dataset.

In some embodiments, the system may determine the first feature vector of the first n-gram statistic of the shared encryption token in the first tokenized representation by determining a first n-gram corresponding to the shared encryption token, determining a second n-gram corresponding to the shared encryption token, and determining an order frequency of the first n-gram and the second n-gram. For example, to determine the first feature vector of the first n-gram statistic for a shared encryption token in a tokenized representation, the system first identifies two specific n-grams—the first and second n-grams—that each include the shared encryption token. These n-grams represent distinct sequences where the shared encryption token appears alongside other tokens, capturing different contextual settings or patterns. After identifying these n-grams, the system calculates the order frequency of the first n-gram in relation to the second n-gram within the tokenized representation. Order frequency indicates how often the first n-gram precedes the second n-gram (or vice versa) within the text, thereby providing insight into the common sequential relationships involving the shared encryption token. This order frequency is a key component in understanding the token's contextual usage and dependency structures. The system encodes this order frequency, along with other relevant data on the first and second n-grams, into a feature vector that captures not only the occurrences of each n-gram but also the directional relationship between them. This feature vector, containing order frequency data, thus reflects both the prevalence and sequential structure associated with the shared encryption token in the dataset. Such a representation is valuable for tasks like predictive text generation, contextual analysis, and pattern recognition, as it enables the system to model and replicate the natural flow and ordering of tokenized information involving the shared encryption token.

At step 410, process 400 (e.g., using one or more components described above) generates a feature weight. For example, the system may generate, using an optimization procedure, a feature weight based on a difference between the first feature vector and the second feature vector.

In some embodiments, the system may generate, using the optimization procedure, the feature weight based on the difference between the first feature vector and the second feature vector by assigning initial weights to each feature in the first feature vector and the second feature vector and computing differences between the initial weights. For example, to generate the feature weight based on the difference between a first feature vector and a second feature vector, the system begins by assigning initial weights to each feature in both vectors. These initial weights are typically set to small random values or defined based on prior knowledge, setting a starting point for the optimization process. Next, the system calculates the difference between the corresponding features in the first and second vectors, resulting in a series of differences that capture the relative variance in feature values between the two vectors. These differences represent the preliminary distinctions between the vectors, highlighting which features contribute more prominently to the variance between the two sets. The system then uses an optimization procedure—such as gradient descent—to iteratively adjust the weights. In each iteration, the system updates the weights to minimize the error or objective function based on the feature differences, refining the weights to align with the features that best capture the distinctive characteristics of each vector. This process continues until the optimization converges, resulting in a final set of feature weights that reflect the meaningful differences between the first and second feature vectors. These optimized feature weights provide a learned representation of feature importance, enabling the system to emphasize key distinctions in downstream tasks like classification, clustering, or similarity analysis.

In some embodiments, the system may generate, using the optimization procedure, the feature weight based on the difference between the first feature vector and the second feature vector by retrieving a target output for a loss function, determining a current output of the loss function, and comparing the target output to the current output. For example, to generate a feature weight based on the difference between a first feature vector and a second feature vector, the system utilizes an optimization procedure involving a loss function, which measures the discrepancy between the current and desired results. Initially, the system retrieves a target output for the loss function, representing the optimal or desired outcome it aims to achieve with the feature weights. Then, the system computes the current output of the loss function based on the initial weights assigned to each feature in the first and second feature vectors. This current output reflects how well the initial weights capture the differences between the two vectors. The system compares the current output of the loss function to the target output, calculating the error or difference between these two values. This error serves as feedback for adjusting the feature weights. Through an iterative process, the system uses optimization algorithms—such as gradient descent—to modify the weights in a direction that reduces the error. With each iteration, the system recalculates the loss function and updates the weights until the current output closely matches the target output, or the error falls below a specified threshold. By refining the weights in this way, the system ultimately determines a set of optimized feature weights that accurately capture the critical differences between the first and second feature vectors, aligning the system's performance with the desired target outcome.

In some embodiments, the system may generate, using the optimization procedure, the feature weight based on the difference between the first feature vector and the second feature vector by assigning feature weights to the first feature vector and the second feature vector and calculating a gradient of a loss based on differences in the feature weights. For example, to generate a feature weight based on the difference between a first feature vector and a second feature vector, the system begins by assigning initial feature weights to each element in both vectors. These initial weights may be set randomly or based on prior knowledge, establishing a starting point for the optimization. Once these weights are assigned, the system calculates the differences in feature values between the first and second vectors, capturing the essential variance between the two sets. Using this variance, the system defines a loss function, which quantifies the error or discrepancy between the current weighted representation and the target outcome. To refine the weights, the system computes the gradient of the loss function with respect to each feature weight. This gradient provides a directional guide, indicating how much each feature weight should be adjusted to reduce the loss effectively. By following the gradient, the system iteratively updates the weights, using an optimization algorithm such as gradient descent, to move closer to the minimum loss. With each iteration, the system recalculates the loss, adjusts the weights based on the gradient, and continues this process until the loss converges or meets a defined threshold. The resulting feature weights reflect the optimized representation of the differences between the first and second feature vectors, enhancing the system's ability to capture and leverage meaningful distinctions between the two for tasks like classification, clustering, or similarity analysis.

At step 412, process 400 (e.g., using one or more components described above) generates a third dataset based on the feature weight. For example, the system may generate a third dataset based on applying the feature weight to the second dataset. In some embodiments, the third dataset may comprise unencrypted replacement data.

In some embodiments, the system may generate the third dataset based on applying the feature weight to the second dataset by using the feature weight as a parameter for synthetic text generation and generating synthetic raw data for the third dataset using the synthetic text generation. To generate a third dataset based on applying feature weights to a second dataset, the system uses the feature weights as parameters to guide synthetic text generation, producing synthetic raw data for the third dataset. These feature weights, optimized to reflect key patterns and distinctions, serve as influential parameters that inform the structure, vocabulary, and style of the generated text. In practice, the system feeds these weights into a synthetic text generation model, such as a language model or neural network, that creates text aligned with the weighted characteristics. The feature weights might influence word frequency, phrase structure, or contextual dependencies, ensuring the synthetic text reflects essential patterns observed in the second dataset.

Using this parameterized generation process, the system produces synthetic data that mirrors the structure and thematic elements of the second dataset without replicating specific content verbatim, ensuring originality and privacy. The synthetic raw data generated in this way forms the third dataset, containing new instances of text that uphold the statistical and contextual nuances of the original data. This third dataset can then be used for training, analysis, or testing while maintaining data integrity and avoiding the use of actual sensitive information. Through this approach, the system effectively transforms weighted characteristics into a fully synthetic dataset that preserves relevant patterns in a secure and compliant manner.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for generating external opensource datasets using dataset tuning of encrypted internal data.
2. The method of the preceding embodiments comprising: receiving a first dataset, wherein the first dataset comprises sensitive data; receiving a second dataset, wherein the second dataset comprises non-sensitive data; generating a first tokenized representation of the first dataset, wherein the first tokenized representation comprises a first encryption of the sensitive data; generating a second tokenized representation of the second dataset, wherein the second tokenized representation comprises a second encryption of the non-sensitive data; determining a shared encryption token in the first tokenized representation and the second tokenized representation; determining a first feature vector of a first n-gram statistic of the shared encryption token in the first tokenized representation; determining a second feature vector of a second n-gram statistic of the shared encryption token in the second tokenized representation; generating, using an optimization procedure, a feature weight based on a difference between the first feature vector and the second feature vector; and generating a third dataset based on applying the feature weight to the second dataset.
3. The method of any one of the preceding embodiments, wherein determining the first feature vector of the first n-gram statistic of the shared encryption token in the first tokenized representation further comprises: determining a first n-gram corresponding to the shared encryption token; and determining a first frequency of the first n-gram in the first tokenized representation.
4. The method of any one of the preceding embodiments, wherein determining the first feature vector of the first n-gram statistic of the shared encryption token in the first tokenized representation further comprises: determining a first n-gram corresponding to the shared encryption token; and determining a second n-gram corresponding to the shared encryption token; and determining a position of the first n-gram in relation to the second n-gram.
5. The method of any one of the preceding embodiments, wherein determining the first feature vector of the first n-gram statistic of the shared encryption token in the first tokenized representation further comprises: determining a first n-gram corresponding to the shared encryption token; determining a second n-gram corresponding to the shared encryption token; and determining a likelihood of the first n-gram preceding the second n-gram.
6. The method of any one of the preceding embodiments, wherein determining the first feature vector of the first n-gram statistic of the shared encryption token in the first tokenized representation further comprises: determining a first n-gram corresponding to the shared encryption token; determining a second n-gram corresponding to the shared encryption token; and determining a position of the first n-gram in relation to the second n-gram.
7. The method of any one of the preceding embodiments, wherein determining the first feature vector of the first n-gram statistic of the shared encryption token in the first tokenized representation further comprises: determining a first n-gram corresponding to the shared encryption token; and determining a first hash value based on the first n-gram in the first tokenized representation.
8. The method of any one of the preceding embodiments, wherein determining the first feature vector of the first n-gram statistic of the shared encryption token in the first tokenized representation further comprises: determining a first n-gram corresponding to the shared encryption token; determining a second n-gram corresponding to the shared encryption token; and determining a first number of text strings in the first tokenized representation comprising the first n-gram and the second n-gram.
9. The method of any one of the preceding embodiments, wherein determining the first feature vector of the first n-gram statistic of the shared encryption token in the first tokenized representation further comprises: determining a first n-gram corresponding to the shared encryption token; determining a second n-gram corresponding to the shared encryption token; determining a third n-gram corresponding to the shared encryption token; and determining a syntactical structure in the first tokenized representation comprising the first n-gram, the second n-gram, and the third n-gram.
10. The method of any one of the preceding embodiments, wherein determining the first feature vector of the first n-gram statistic of the shared encryption token in the first tokenized representation further comprises: determining a first n-gram corresponding to the shared encryption token; and determining a first conditional n-gram distribution of the first n-gram in the first tokenized representation.
11. The method of any one of the preceding embodiments, wherein determining the first feature vector of the first n-gram statistic of the shared encryption token in the first tokenized representation further comprises: determining a first n-gram corresponding to the shared encryption token; determining a second n-gram corresponding to the shared encryption token; and determining an order frequency of the first n-gram and the second n-gram.
12. The method of any one of the preceding embodiments, wherein generating the first tokenized representation of the first dataset comprises: determining a first word in the first dataset; and generating a byte pair encoding of the first word.
13. The method of any one of the preceding embodiments, wherein generating, using the optimization procedure, the feature weight based on the difference between the first feature vector and the second feature vector further comprises: assigning initial weights to each feature in the first feature vector and the second feature vector; and computing differences between the initial weights.
14. The method of any one of the preceding embodiments, wherein generating, using the optimization procedure, the feature weight based on the difference between the first feature vector and the second feature vector further comprises: retrieving a target output for a loss function; determining a current output of the loss function; and comparing the target output to the current output.
15. The method of any one of the preceding embodiments, wherein generating, using the optimization procedure, the feature weight based on the difference between the first feature vector and the second feature vector further comprises: assigning feature weights to the first feature vector and the second feature vector; and calculating a gradient of a loss based on differences in the feature weights.
16. The method of any one of the preceding embodiments, generating the third dataset based on applying the feature weight to the second dataset further comprises: using the feature weight as a parameter for synthetic text generation; and generating synthetic raw data for the third dataset using the synthetic text generation.
17. One or more non-transitory, computer-readable mediums storing instructions that, when executed by a data processing apparatus, cause the data processing apparatus to perform operations comprising those of any of embodiments 1-16.
18. A system comprising one or more processors; and memory-storing instructions that, when executed by the processors, cause the processors to effectuate operations comprising those of any of embodiments 1-16.
19. A system comprising means for performing any of embodiments 1-16.

What is claimed is:

1. A system for generating external opensource datasets using dataset tuning of encrypted internal datasets, the system comprising:
one or more processors; and
one or more non-transitory, computer-readable media, comprising instructions that, when executed by the one or more processors, cause operations comprising:
receiving a first dataset, wherein the first dataset comprises raw sensitive data of internal communications, and wherein the raw sensitive data is unencrypted;
receiving a second dataset, wherein the second dataset comprises raw non-sensitive data of communications from a plurality of opensource locations, and wherein the raw non-sensitive data is unencrypted;
generating a first tokenized representation of the first dataset, wherein the first tokenized representation comprises a first encryption of the raw sensitive data;
generating a second tokenized representation of the second dataset, wherein the second tokenized representation comprises a second encryption of the raw non-sensitive data;
determining a shared encryption token in the first tokenized representation and the second tokenized representation;
determining a first feature vector of a first n-gram statistic of the shared encryption token in the first tokenized representation;
determining a second feature vector of a second n-gram statistic of the shared encryption token in the second tokenized representation;
generating, using an optimization procedure, a feature weight based on a difference between the first feature vector and the second feature vector; and
generating a third dataset based on applying the feature weight to the second dataset, wherein the third dataset comprises unencrypted replacement data.

2. A method for generating external opensource datasets using dataset tuning of encrypted internal data, the method comprising:
receiving a first dataset, wherein the first dataset comprises sensitive data;
receiving a second dataset, wherein the second dataset comprises non-sensitive data;
generating a first tokenized representation of the first dataset, wherein the first tokenized representation comprises a first encryption of the sensitive data;
generating a second tokenized representation of the second dataset, wherein the second tokenized representation comprises a second encryption of the non-sensitive data;
determining a shared encryption token in the first tokenized representation and the second tokenized representation;
determining a first feature vector of a first n-gram statistic of the shared encryption token in the first tokenized representation;
determining a second feature vector of a second n-gram statistic of the shared encryption token in the second tokenized representation;
generating, using an optimization procedure, a feature weight based on a difference between the first feature vector and the second feature vector; and
generating a third dataset based on applying the feature weight to the second dataset.

3. The method of claim 2, wherein determining the first feature vector of the first n-gram statistic of the shared encryption token in the first tokenized representation further comprises:
determining a first n-gram corresponding to the shared encryption token; and
determining a first frequency of the first n-gram in the first tokenized representation.

4. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token; and
determining a position of the first n-gram in relation to the second n-gram.

5. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token; and
determining a likelihood of the first n-gram preceding to the second n-gram.

6. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token; and
determining a position of the first n-gram in relation to the second n-gram.

7. The method of claim 2, wherein determining the first feature vector of the first n-gram statistic of the shared encryption token in the first tokenized representation further comprises:
determining a first n-gram corresponding to the shared encryption token; and
determining a first hash value based on the first n-gram in the first tokenized representation.

8. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token; and
determining a first number of text strings in the first tokenized representation comprising the first n-gram and the second n-gram.

9. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token;
determining a third n-gram corresponding to the shared encryption token; and
determining a syntactical structure in the first tokenized representation comprising the first n-gram, the second n-gram, and the third n-gram.

10. The method of claim 2, wherein determining the first feature vector of the first n-gram statistic of the shared encryption token in the first tokenized representation further comprises:
determining a first n-gram corresponding to the shared encryption token; and
determining a first conditional n-gram distribution of the first n-gram in the first tokenized representation.

11. The method of claim 2, wherein determining the first feature vector of the first n-gram statistic of the shared encryption token in the first tokenized representation further comprises:
determining a first n-gram corresponding to the shared encryption token;
determining a second n-gram corresponding to the shared encryption token; and
determining an order frequency of the first n-gram and the second n-gram.

12. The method of claim 2, wherein generating the first tokenized representation of the first dataset comprises:
determining a first word in the first dataset; and
generating a byte pair encoding of the first word.

13. The method of claim 2, wherein generating, using the optimization procedure, the feature weight based on the difference between the first feature vector and the second feature vector further comprises:
assigning initial weights to each feature in the first feature vector and the second feature vector; and
computing differences between the initial weights.

14. The method of claim 2, wherein generating, using the optimization procedure, the feature weight based on the difference between the first feature vector and the second feature vector further comprises:
retrieving a target output for a loss function;
determining a current output of the loss function; and
comparing the target output to the current output.

15. The method of claim 2, wherein generating, using the optimization procedure, the feature weight based on the difference between the first feature vector and the second feature vector further comprises:
assigning feature weights to the first feature vector and the second feature vector; and
calculating a gradient of a loss based on differences in the feature weights.

16. The method of claim 2, generating the third dataset based on applying the feature weight to the second dataset further comprises:
using the feature weight as a parameter for synthetic text generation; and
generating synthetic raw data for the third dataset using the synthetic text generation.

17. One or more non-transitory, computer-readable media, comprising instructions that, when executed by one or more processors, cause operations comprising:
receiving a first dataset and a second dataset, wherein the first dataset comprises sensitive data, and wherein the second dataset comprises non-sensitive data;
generating a first tokenized representation of the first dataset and a second tokenized representation of the second dataset;
determining a shared token in the first tokenized representation and the second tokenized representation;
determining a first feature vector based on the shared token in the first tokenized representation and a second feature vector based on the shared token in the second tokenized representation;
generating, using an optimization procedure, a feature weight based on a difference between the first feature vector and the second feature vector; and
generating a third dataset based on applying the feature weight to the second dataset.

18. The one or more non-transitory, computer-readable media of claim 17, wherein determining the first feature vector based on the shared token further comprises:
determining a first n-gram corresponding to the shared token; and
determining a first frequency of the first n-gram in the first tokenized representation.

19. The one or more non-transitory, computer-readable media of claim 17, wherein determining the first feature vector based on the shared token further comprises:
determining a first n-gram corresponding to the shared token;
determining a second n-gram corresponding to the shared token; and
determining a position of the first n-gram in relation to the second n-gram.

20. The one or more non-transitory, computer-readable media of claim 17, wherein generating, using the optimization procedure, the feature weight based on the difference between the first feature vector and the second feature vector; further comprises:
assigning feature weights to the first feature vector and the second feature vector; and
calculating a gradient of a loss based on differences in the feature weights.
